(19) United States
(12) Patent Application Publication
(10) Pub. No.: US 2026/0290388 A1
(43) Pub. Date: Sep. 24, 2026

(54) MAGNETIC HEAD AND MAGNETIC DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Yuuichi YAMADA, Kawasaki Kanagawa (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 19/269,120

(22) Filed: Jul. 15, 2025

(30) Foreign Application Priority Data
Mar. 18, 2025 (JP) 2025-043493

(51) Int. Cl. G11B 5/48

(52) U.S. Cl. CPC G11B 5/4826

(57) ABSTRACT

According to one embodiment, a magnetic head includes a head slider, a write head, and first and second read heads. The write head has a center portion on a reference axis of the slider. A center portion of the first read head is spaced apart from the reference axis in a first side direction and positioned away from the center portion of the write head by a first interval in the longitudinal direction. A center portion of the second read head is spaced apart from the reference axis in a second side direction opposite to the first side direction and positioned away from the center portion of the write head by a second interval in the longitudinal direction. The first interval and the second interval are formed to be 2 μm or more and 3 μm or less.

### CROSS-REFERENCE TO RELATED APPLICATIONS

This application is based upon and claims the benefit of priority from Japanese Patent Application No. 2025-043493, filed Mar. 18, 2025, the entire contents of which are incorporated herein by reference.

### FIELD

Embodiments described herein relate generally to a magnetic head and a magnetic disk device comprising the same.

### BACKGROUND

As a magnetic disk device, for example, a hard disk drive (HDD) comprises a magnetic disk (recording medium) disposed so as to be rotatable in a housing, a magnetic head that perform reading and writing information with respect to the magnetic disk, and an actuator (actuator assembly) that supports the magnetic head so as to be movable relative to the magnetic disk. The recording layer of the magnetic disk includes a servo data area where servo data containing the position information of the magnetic head is recorded, and a data recording area where magnetic information is recorded. The data recording area corresponds to data tracks extending in the circumferential direction of the magnetic disk.

The magnetic head includes a write head that records magnetic information on the data recording area, and a read head that reads servo data from the servo data area and magnetic information from the data recording area. Usually, the write head (, which may as well be referred to as a writer) and the read head (, which may as well be referred to as a reader) are arranged along the longitudinal direction of the head slider at an interval therebetween.

The actuator includes an actuator block supported so as to be rotatable, and a plurality of suspension assemblies each extending from the actuator block and each supporting a magnetic head at a tip end. The magnetic heads are each arranged such that the longitudinal center axis is oriented in a direction passing through the rotation center of the actuator block. When the actuator rotates, the respective magnetic head is moved in a substantially radial direction of the magnetic disk between the outermost circumference and the innermost circumference of the respective magnetic disk.

On the other hand, the servo data is position information, and therefore if the servo data is erased or overwritten, the position of the respective magnetic head can no longer be detected or controlled. For this reason, when the reader reads the servo data information at the end of data recording, the data recording operation is terminated at that point, thereby making it possible to prevent overwriting on the servo data area. As a result, a blank section exists between the data recording end and the servo data area, thus causing data loss.

The size (length) of the above-mentioned blank section is influenced by the distance between the reader and writer of the recording head in the circumferential direction (data recording direction) of the magnetic disk. As the distance between the reader and writer in the longitudinal direction of the slider increases, the blank section becomes larger, resulting in greater data loss in the magnetic disk.

Incidentally, when the angle made between the data recording direction (circumferential direction) of the data recording area and the longitudinal direction of the slider is defined as a skew angle, the skew angle changes depending on the radial position of the magnetic head relative to the magnetic disk. The, as the skew angle changes, the distance between the read and write heads in the data recording direction also changes. Therefore, to prevent overwriting of the above-described servo data area at all positions on the magnetic disk, it is necessary to maintain the distance between the reader and writer in the longitudinal direction of the slider at a certain value or greater. As a result, the above-mentioned blank section enlarges, leading to increased recording loss.

### BRIEF DESCRIPTION OF THE DRAWINGS

FIG. 1 is a block diagram briefly showing a hard disk drive (HDD) according to the first embodiment.

FIG. 2 is a side view showing a magnetic head, a suspension, and a magnetic disk in the HDD.

FIG. 3 is a plan view schematically showing an ABS side of the magnetic head.

FIG. 4 is a cross-sectional view of a head portion of the magnetic head and a respective magnetic disk.

FIG. 5 is a plan view of the head portion, illustrating relative positions of a write head and a pair of read heads in a support surface (ABS) of the magnetic head.

FIG. 6 is a plan view of the head portion, schematically showing relative positions of the write head and one of the read heads in a tilted state at a certain skew angle.

FIG. 7 is a cross-sectional view schematically showing the magnetic head and a part of a magnetic recording layer of the magnetic disk.

FIG. 8 is a plan view showing the relationship between one surface of the magnetic disk and the radial position of the magnetic head.

FIG. 9 is a plan view of the head section, schematically showing the relative positions of the write head and the pair of read heads and the recording tracks when the skew angle is zero.

FIG. 10 is a plan view of the head portion, schematically showing the relative positions of the write head, the pair of read heads, and the recording tracks when the skew angle is positive.

FIG. 11 is a plan view of the head portion, schematically showing the relative positions of the write head, the pair of read heads, and the recording tracks when the skew angle is negative.

FIG. 12 is a plan view of a head portion, showing an arrangement of a write head and a pair of read heads on a support surface (ABS) of a magnetic head of an HDD according to the second embodiment.

### DETAILED DESCRIPTION

Various embodiments will be described hereinafter with reference to the accompanying drawings. In general, according to one embodiment, a magnetic head comprises a head slider including a rectangular support surface facing a recording medium and a reference axis extending in a longitudinal direction of the support surface; a write head provided on the head slider, which applies a recording magnetic field to the recording medium and includes a head tip portion exposed to the support surface; and a first read head and a second read head, each including a head tip portion provided on the head slider and exposed to the support surface, which read information recorded in a recording area of the recording medium and position information recorded in a servo data area of the recording medium. The head tip portion of the write head includes a center portion placed on the reference axis. The head tip portion of the first read head includes a center portion spaced apart from the reference axis by a first offset distance in a first side direction perpendicular to the reference axis, and in the longitudinal direction, spaced apart from the center portion of the head tip portion of the write head by a first interval. The head tip portion of the second read head includes a center portion spaced apart from the reference axis by a second offset distance in a second side direction which is opposite to the first side direction, and in the longitudinal direction, spaced apart from the center portion of the head tip portion of the write head by a second interval. The first interval and the second interval are formed to be 2 μm or more and 3 μm or less.

Note that the disclosure is merely an example, and any appropriate modifications that are easily conceivable by those skilled in the art while maintaining the essence of the invention are naturally included in the scope of the present invention. In addition, the drawings are provided to clarify the explanation, and the width, thickness, shape, etc., of each part may be represented schematically compared to the actual configuration, but these are merely examples and do not limit the interpretation of the present invention. Furthermore, in this specification and the figures, the same reference numerals are used for elements previously described in relation to the preceding figures, and detailed descriptions may be omitted or simplified as appropriate.

### First Embodiment

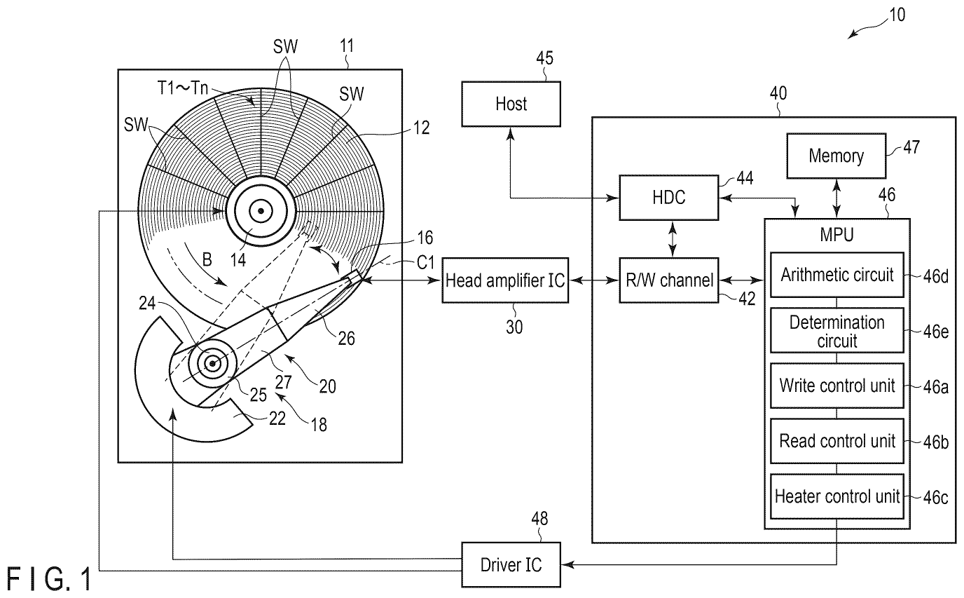

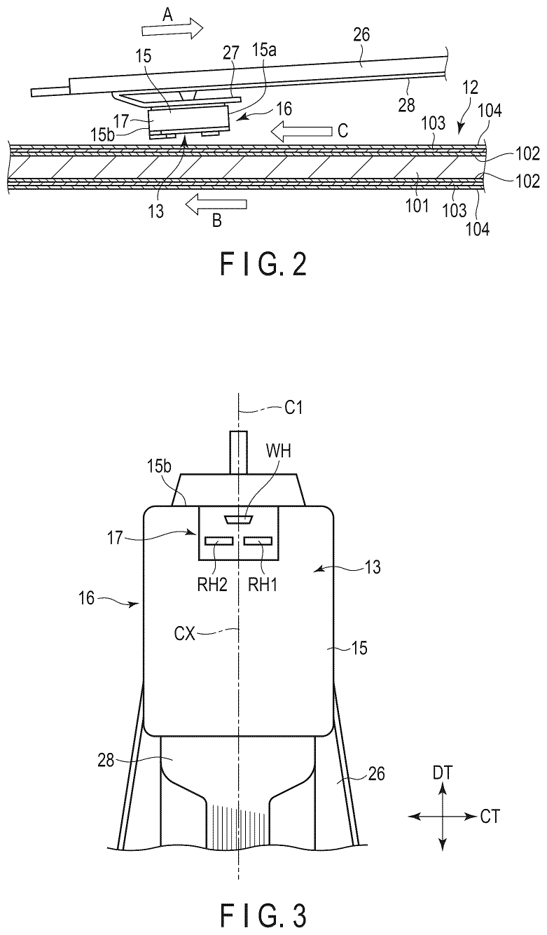

As magnetic disk device, a hard disk drive (HDD) according to the embodiment, will be described in detail. FIG. 1 is a block diagram briefly showing an HDD according to the first embodiment, and FIG. 2 is a side view showing a magnetic head in a flying state and a magnetic disk.

As shown in FIG. 1, the HDD 10 includes a rectangular housing 11, a magnetic disk 12 installed in the housing 11 as a recording medium, a spindle motor 14 that supports and rotates the magnetic disk 12, and a plurality of magnetic heads 16 that perform recording (write) and reading of data with respect to the magnetic disk 12. Further, the HDD 10 comprises an actuator 18 that moves and positions the magnetic heads 16 to any track on the magnetic disk 12. The actuator 18 includes a carrier assembly 20 that supports the magnetic heads 16 so as to be movable and a voice coil motor (VCM) 22 that pivots the carrier assembly 20.

The carriage assembly 20 includes an actuator block 25 supported so as to be rotatable on the housing 11 by a bearing unit 24. The actuator block 25 includes a plurality of arms 27 integrated as one body. The carriage assembly 20 includes a suspension 26 extending from each of the arms 27. The magnetic head 16 is supported at the extending end of the suspension 26.

The arms 27 and the suspensions 26 each have a central axis C1 extending while passing through a rotational center G1. The magnetic head 16 is positioned above the central axis C1. As the carriage assembly 20 rotates around the rotational center G1, the magnetic head 16 is moved in a radial direction of the magnetic disk 12 between an outer circumferential edge portion and an inner circumferential edge portion thereof.

As shown in FIG. 1, the HDD 10 includes a head amplifier IC 30 that drives the magnetic head 16, a main controller 40, and a driver IC 48. The head amplifier IC 30 is provided, for example, in the carriage assembly 20 and electrically connected to the magnetic head 16. The head amplifier IC 30 includes a recording current supply circuit that supplies recording current to the recording coil of the magnetic head 16, an amplifier that amplifies signals read by the magnetic head 16, and the like.

The main controller 40 and the driver IC 48 are, for example, configured as a control circuit board (not shown) provided on a rear surface side of the housing 11. The main controller 40 includes an R/W channel 42, a hard disk controller (HDC) 44, a microprocessor (MPU) 46, a memory 47, and the like. The main controller 40 is electrically connected to the magnetic head 16 via the head amplifier IC 30. Further, the main controller 40 is electrically connected to the VCM 22 and the spindle motor 14 via the driver IC 48. The HDC 44 is connectable to a host computer 45.

The memory 47 stores various data, such as table data indicating the relationship between the radial position of the magnetic head and the skew angle.

In the main controller 40, for example, the MPU 46 includes a write control unit 46a that controls the write head, a read control unit 46b that controls the read head, a heater control unit 46c that controls the power to be supplied to the thermal actuator, an arithmetic circuit 46d, a determination circuit 46e, and the like. As will be described later, the arithmetic circuit 46d calculates the radial position of the magnetic head 16 on the magnetic disk 12 based on the servo data (position information) read by the read head, and calculates the skew angle of the magnetic head based on the radial position. The determination circuit 46e selects and determines the read head to be used according to the calculated skew angle.

As shown in FIGS. 1 and 2, the magnetic disk 12 is configured as a perpendicular magnetic recording medium. The magnetic disk 12 has a substrate 101 formed in a circular plate shape having a diameter of, for example, 96 mm (approximately 3.5 inches) and made of a non-magnetic material. On each of upper and lower surfaces of the substrate 101, a soft magnetic layer 102, a magnetic recording layer 103 having magnetic anisotropy in a perpendicular direction to the surface of the magnetic disk 12, and a protective film 104 are sequentially stacked. Note that there are a plurality of, for example, ten magnetic disks 12 provided. These magnetic disks 12 are fitted on the hub of the spindle motor 14 so as to be coaxial with each other. The magnetic disks 12 are rotated at a predetermined speed in a direction of arrow B by the spindle motor 14.

As shown in FIG. 1, on each of the surfaces (magnetic recording layers) of each magnetic disk 12, a number of concentric recording tracks T1 to Tn, which give rise to data recording areas, are formed. Each of the recording tracks T1 to Tn extends in the circumferential direction of the respective magnetic disk 12, and this circumferential direction is the recording direction. Further, on each magnetic recording layer of each magnetic disk 12, a number of servo data areas SW are formed to extend in the radiating direction (direction of radius of the disk). The servo data areas SW are arranged at equal intervals in the circumferential direction. Each servo data area SW stores data containing position information.

As shown in FIG. 2, the magnetic head 16 is supported at the extending end of each of the suspensions 26. The magnetic head 16 is electrically connected to the head amplifier IC 30 via a wiring member (flexure) 28 provided in the carriage assembly 20.

The magnetic head 16 is configured as a flying-type head, and includes a slider 15 formed into a substantially rectangular parallelepiped shape and a head portion 17 formed at an end of the flow-out (trailing) side (15b) of the slider 15. The slider 15 is formed, for example, from a sintered body of alumina and titanium carbide (AlTiC), and the head portion 17 is formed from multiple thin films. The slider 15 is mounted on a gimbal portion 30 of the wiring member 28.

The slider 15 has a rectangular air bearing surface (ABS) (, which may as well be referred to as a support surface) 13 facing the surface of the magnetic disk 12. The slider 15 is maintained in a state where it is flying at a predetermined height above the surface of the magnetic disk 12 by the air flow C generated between the disk surface and the ABS 13 due to the rotation of the magnetic disk 12. As the magnetic disk 12 rotates, the magnetic head 16 travels in the direction of arrow A (head travel direction) with respect to the magnetic disk 12, which is opposite to the rotation direction B of the disk.

FIG. 3 is a plan view of the tip end portion of the suspension and the magnetic head 16 as seen from an ABS 13 side. In the figure, the longitudinal direction of the ABS 13 is defined as a track direction DT, and the direction perpendicular to the longitudinal direction is defined as a cross-track direction WT.

As shown in FIG. 3, the ABS 13 of the slider 15 is formed into a rectangular shape in plan view and has a central axis C1 extending parallel to the longitudinal direction (track direction DT). The central axis C1 extends while passing through the center of the ABS 13 along the width direction (cross-track direction WT). The slider 15 is mounted on the suspension 26 in such an orientation that the central axis C1 thereof is aligned with or parallel to the central axis C1 of the suspension 26.

The ABS 13 of the slider 15 further has a reference axis CX extending parallel to the longitudinal direction. The reference axis CX serves as a referential axis for the arrangement of the write head (, which may as well be referred to as a writer) WH and a pair of read heads (, each of which may as well be referred to as a reader) RH1 and RH2, as will be described later. In this embodiment, the reference axis CX is set at the same position as that of the central axis C1. That is, the reference axis CX extends while passing through the center of the ABS 13 along the width direction (cross-track direction WT).

As described above, in this embodiment, the reference axis CX is a common axis with the center axis C1, and therefore in the following descriptions, the reference axis CX may as well be replaced with the center axis C1, and the notation for the reference axis CX may be omitted.

Note that the reference axis CX may not necessarily be common with the center axis C1, and may be set at a position offset from the center axis C1 in the width direction (cross-track direction WT) of the ABS 13.

As will be described later, the head portion 17 includes the write head WH and the pair of read heads RH1 and RH2. In one example, the write head WH is located on the reference axis CX, and the pair of read heads RH1 and RH2 are arranged on respective sides of the reference axis CX.

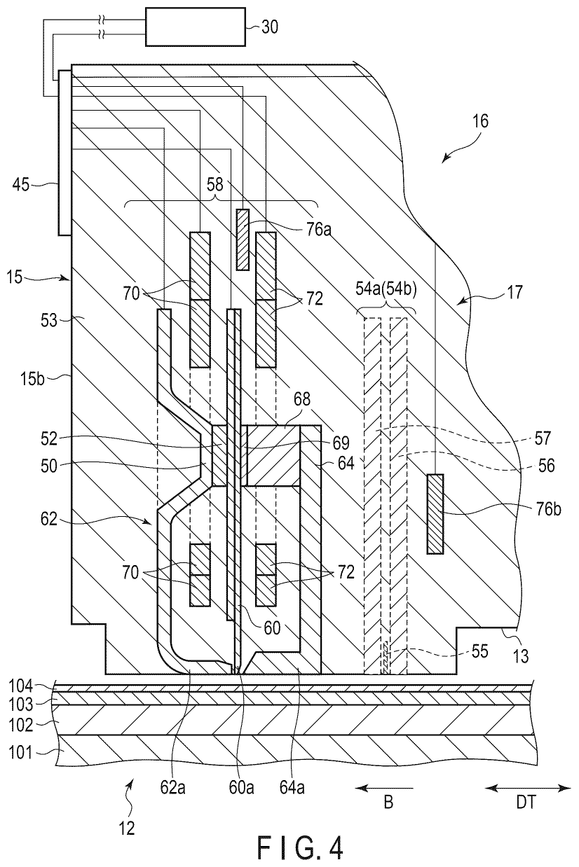

FIG. 4 is a partially enlarged cross-sectional view showing the head portion 17 of the magnetic head 16 and the magnetic disk 12. As shown in the figure, the head portion 17 includes read heads 54a and 54b and a recording head 58, which are formed at the end portion on the trailing end 15b side of the slider 15 by a thin film process, and is formed as a separated magnetic head. The read heads 54a, 54b, and the recording head 58 are covered by a non-magnetic protective insulating film 53, except for the portions exposed to the ABS 13 of the slider 15. The protective insulating film 53 constitutes the outer shape of the head portion 17.

Note that in FIG. 4, only one of the read heads, that is, the head 54a, is shown.

In one example, the recording head 58 includes a main magnetic pole 60 that generates a recording magnetic field perpendicular to the surface of the magnetic disk 12, a trailing shield (write shield magnetic pole) 62 that faces the trailing side of the main magnetic pole 60 with a write gap therebetween, a leading shield 64 that faces the leading side of the main magnetic pole 60, and an assist element (not shown) disposed between the main magnetic pole 60 and the trailing shield 62 within the write gap. The main magnetic pole 60 and the trailing shield 62 constitutes a first magnetic core that forms a magnetic path, and the main magnetic pole 60 and the leading shield 64 constitutes a second magnetic core that forms a magnetic path. The recording head 58 has a first recording coil 70 wound around the first magnetic core and a second recording coil 72 wound around the second magnetic core.

The main magnetic pole 60 extends substantially perpendicular to the ABS 13. The tip end portion 60a of the main magnetic pole 60 on the ABS 13 side is tapered down toward the ABS 13 and formed as a columnar shape narrow as compared to the other portions. The tip surface of the main magnetic pole 60 is exposed to the ABS 13 of the slider 15. As will be described later, for convenience, the tip portion of the main magnetic pole, which is exposed to the ABS 13 is denoted as the write head WH.

The trailing shield 62 includes a first connection portion 50 connected to the main magnetic pole 60. The first connection portion 50 is magnetically connected to an upper portion of the main magnetic pole 60, that is, the portion of the main magnetic pole 60 away from the ABS 13, via a non-conductive member 52. The first recording coil 70 is wound around the first connection portion 50, for example. When writing a signal to the magnetic disk 12, a recording current is passed through the first recording coil 70, and thus the first recording coil 70 excites the main magnetic pole 60 to cause a magnetic flux to flow to the main magnetic pole 60.

The leading shield 64 has a second connection portion 68 that is joined to the main magnetic pole 60 at a position separated away from the ABS 13. The second connection portion 68 is, for example, formed of a soft magnetic material and magnetically connected to the upper portion of the main magnetic pole 60, that is, the portion of the main magnetic pole 60 away from the ABS 13, via a non-conductive material 69. With this configuration, the second connection portion 68 forms a magnetic circuit together with the main magnetic pole 60 and the leading shield 64. The second recording coil 72 of the recording head 58 is disposed, for example, to be wound around the second connection portion 68 and thus apply a magnetic field to this magnetic circuit.

The first recording coil 70 and the second recording coil 72 are connected to connection terminals 43 via wiring lines, respectively, and further connected to the head amplifier IC via the flexure 28.

The read heads 54a and 54b are provided on the leading side, that is, the inflow side, of the recording head 58 in the down-track direction DT. Each of the read heads 54a and 54b includes a magnetoresistance effect element 55 and, in the down-track direction DT, a first magnetic shielding film 56 and a second magnetic shielding film 57 arranged on the leading side and trailing side of the magnetoresistance effect element 55, respectively, such as to sandwich the magnetoresistance effect element 55 therebetween. The magnetoresistance effect element 55, the first and second magnetic shielding films 56 and 57 are provided to extend substantially perpendicular to the ABS 13. The lower ends of the magnetoresistance effect element 55, the first and second magnetic shielding films 56 and 57 are exposed to the ABS 13.

As will be described later, for convenience, the lower end portions (tip portions) of the magnetoresistance effect element 55 and the first and second magnetic shielding films 56 and 57 exposed to the ABS 13 are denoted as read heads RH1 or RH2.

The magnetic head 16 further comprises a first heater (write heater) 76a and a second heater (read heater) 76b as heating means for adjusting the flying amount of the magnetic head. The first heater 76a is provided in the vicinity of the recording head 58, for example, between the first recording coil 70 and the second recording coil 72, near the main magnetic pole 60. The second heater 76b is provided in the vicinity of the read heads 54a and 54b. The first heater 76a and the second heater 76b are connected to the connection terminals 43 via wiring lines, respectively, and further connected to the head amplifier IC 30 via the flexure 28.

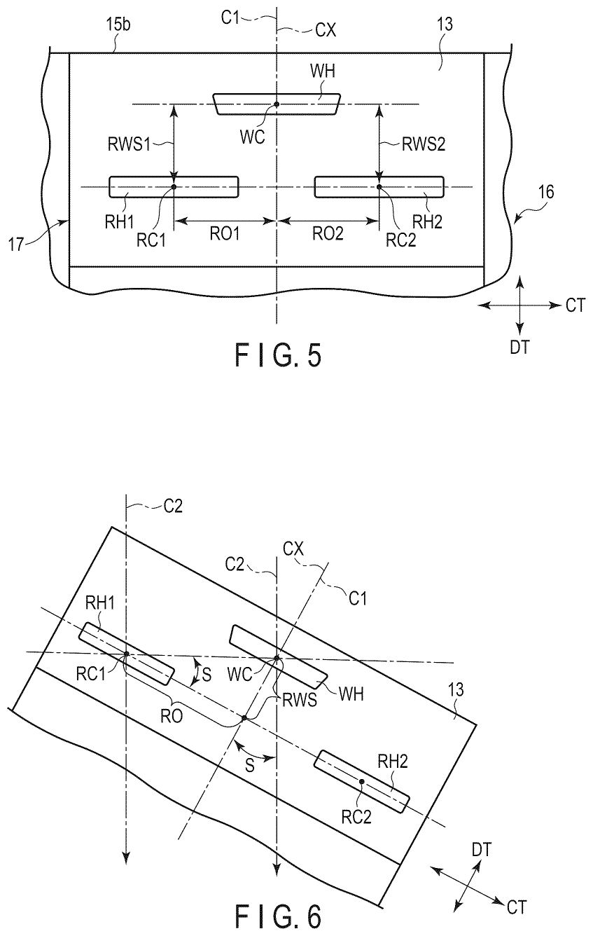

FIG. 5 is a plan view schematically showing an example of the arrangement of the head portion 17 in the ABS 13.

In FIG. 5 and other figures to be explained later, the tip end of the main magnetic pole, exposed to the ABS 13 is referred to as a write head WH, and the lower end portions (tip ends) of the magnetoresistance effect elements 55 and the first and second magnetic shielding films 56 and 57, which are exposed to the ABS 13 are referred to as read heads RH1 and RH2, respectively.

Now, an example of the arrangement of the write head WH, read head RH1, and read head RH2 with relative to each other in the ABS 13 will be described.

As shown in FIG. 5, the write head RH has a substantially rectangular shape, in which its longitudinal direction is oriented parallel to the cross-track direction CT of the ABS 13, and positioned at the intersection with the reference axis CX. The center point (center portion) WC of the write head RH is located on the reference axis CX.

The read heads RH1 and RH2 each have a substantially rectangular shape and disposed on the side of the leading end of the slider 15 with respect to the write head RH so as to be spaced apart from each other. The read heads RH1 and RH2 are disposed in such orientation that their longitudinal directions are aligned parallel to the cross-track direction CT of the ABS 13. The read heads RH1 and RH2 are disposed so as to be apart from each other in the cross-track direction CT and also shift respectively (offset) from the reference axis CX in the cross-track direction CT. In other words, the read heads RH1 and RH2 are arranged on the respective sides of the reference axis CX.

The center point (center portion) RC1 of the read head RH1 is located away from the reference axis CX in one direction (the left side in FIG. 5) of the cross-track direction CT by an interval (first off-track distance) RO1. In one example, the distance RO1 is set to 7 to 12 μm.

In the down-track direction DT, the center point RC1 of the read head RH1 is located at a distance (first interval) RWS1 from the center point WC of the right head WH. In one example, the distance RWS1 is set to 2 to 3 μm.

The center point (center portion) RC2 of the read head RH2 is located at a distance (second off-track distance) RO2 in an opposite direction to the cross-track direction CT (the right side in FIG. 5) relative to the reference axis CX. In one example, the distance RO2 is set to 7 to 12 μm.

In the down-track direction DT, the center point RC2 of the read head RH2 is located at an interval (second distance) RWS2 from the center point WC of the write head WH. In one example, the distance RWS2 is set to 2 to 3 μm.

In this embodiment, when manufacturing errors are not considered, the distances RO1 and RO2 are set to the same dimension, and the distances RWS1 and RWS2 are also set to the same dimension.

Note that, as will be described later, the distances RO1 and RO2 may be set to different dimensions, and similarly, the distances RWS1 and RWS2 may be set to different dimensions.

The write head WH and the read heads RH1 and RH2 are arranged such that, even when the magnetic head 16 is moved to the radial position where the skew angle is at maximum, the read heads RH1 and RH2 are not positioned behind (trailing end side of) the write head WH in the circumferential direction (recording direction) of the magnetic disk 12.

FIG. 6 is a plan view schematically showing an example of the arrangement of the heads in such a configuration that the write head WH and the read heads RH1 are positioned at the same position in the circumferential direction (recording direction) C2 when the magnetic head 16 is moved to the radial position where the skew angle S is at maximum.

In the configuration illustrated, the distance RWS between the write head WH and the read head RH1 in the down-track direction DT, and the distance RO between the write head WH and the read head RH1 in the cross-track direction CT, satisfy the relationship: tanS =RW/RO. For example, when the maximum skew angle S is set to 15 degrees, the distance RWS is set to an upper limit of 3 μm and a lower limit of 2 μm, and the distance RO is set to an upper limit of 11.2 μm and a lower limit of 7.46 μm. By setting the distances RWS and RO within the above-mentioned conditions (upper and lower limits), even when the magnetic head 16 moves to the radial position where the maximum skew angle is reached, such a head configuration can be achieved that the read heads RH1 and RH2 are positioned behind (trailing end side) the write head WH in the circumferential direction (recording direction C2) of the magnetic disk 12.

In the operation of the HDD 10 configured as described above, the main controller 40 drives the spindle motor 14 by the driver IC 48 under the control of the MPU 46 so as to rotate the magnetic disk 12 at a predetermined speed. The main controller 40 drives the VCM 22 by the driver IC 48 so as to move and position the magnetic head 16 on the desired track of the magnetic disk 12. The ABS 13 of the magnetic head 16 faces the disk surface with a gap therebetween. In this state, information is written to the magnetic disk 12 by the write head WH, and recorded information or position information is read out by either one of the read heads RH1 and RH2.

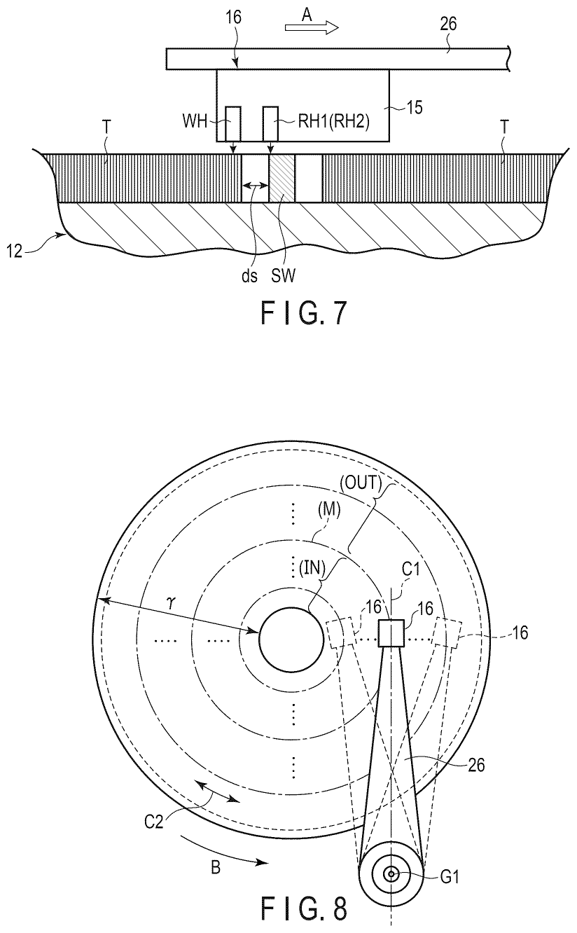

FIG. 7 is a cross-sectional view schematically showing the magnetic head 16 and the magnetic disk 12 during recording operation. As shown in the figure, during recording operation, the magnetic head 16 travels in the arrow A direction (recording direction C2) relative to the magnetic recording layer of the magnetic disk 12, and the write head WH sequentially writes recording information to the track T, which is the recording area. At this point, when the read head RH1 (or RH2) reaches the servo data area SW, that is, when reading of the position information of the servo data area SW is started, the main controller 40 temporarily stops the write operation of the write head WH. Then, the write operation of the write head WH is resumed when the write head WH has passed through the servo data area SW.

When the above-described recording operation is performed, a non-recording area ds, where information is not recorded, is formed between the recording area (track T) and the servo data area SW. This non-recording area ds causes recording loss and should therefore be reduced. As shown in FIG. 7, the width (length) of the non-recording area ds corresponds to the interval between the write head WH and the read head RH1 (or RH2) in the recording direction (circumferential direction). Therefore, in order to reduce the non-recording area ds, it is necessary to shorten the above-described interval.

In the magnetic head 16 of the present embodiment, the interval (interval in circumferential direction) between the write head WH and the read head RH1 (or RH2) in the recording direction varies according to the radial position and skew angle of the magnetic head 16.

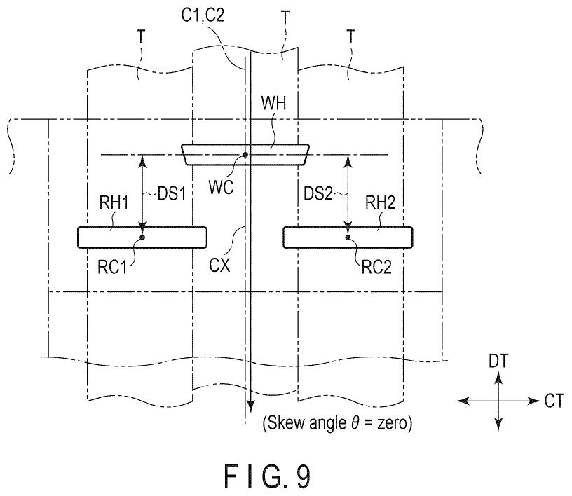

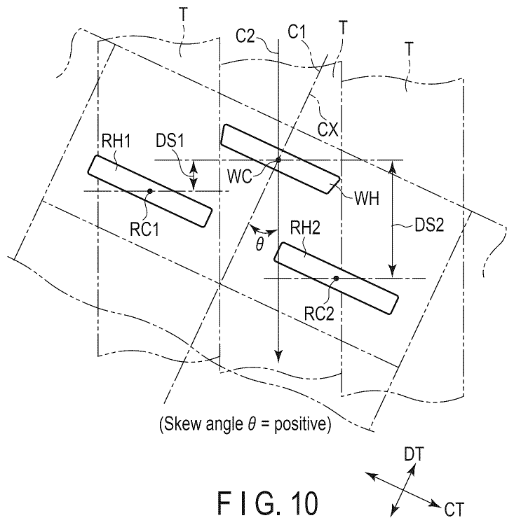

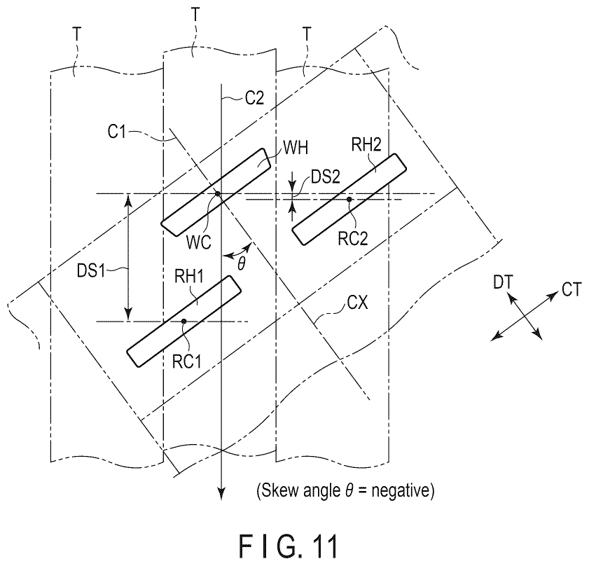

FIG. 8 is a plan view schematically showing a magnetic disk and the magnetic head which has moved to a different radial position. FIG. 9 is a plan view schematically showing the configuration of the head portion at the time when the magnetic head is moved to a radial intermediate position (M). FIG. 10 is a plan view schematically showing the configuration of the head portion at the time when the magnetic head is moved to the outer circumferential region (OUT) in the radial direction of the magnetic head. FIG. 11 is a plan view schematically showing the configuration of the head portion at the time when the magnetic head moves to the inner circumferential region (IN) in the radial direction.

As shown in FIGS. 8 and 9, when the magnetic head 16 is located at the radial intermediate position (M) in the radial direction of the magnetic disk 12, the central axis C1 of the slider is parallel to the recording direction (circumferential direction) C2 of the magnetic disk 12, and the skew angle θ is approximately zero. Therefore, the distance (circumferential direction distance) DS1 between the write head WH and the read head RH1 in the recording direction C2 is the same as the distance (circumferential direction distance) DS2 between the write head WH and the read head RH2 in the recording direction C2.

As shown in FIGS. 8 and 10, when the magnetic head 16 is located in the outer circumferential region (OUT) in the radial direction of the magnetic disk 12, the center axis C1 of the slider forms a skew angle θ (positive) with respect to the recording direction (circumferential direction) C2 of the magnetic disk 12. When the skew angle θ is a positive angle, the distance DS1 between the write head WH and the read head RH1 in the recording direction C2 is smaller than the distance DS2 between the write head WH and the read head RH2 in the recording direction C2, for example, a half of the distance DS2 or less.

Therefore, when the magnetic head 16 is located in the outer circumferential region (OUT) in the radial direction of the magnetic disk 12, the length of the non-recording region ds can be shortened by reading the servo data using the read head RH1.

As shown in FIGS. 8 and 11, when the magnetic head 16 is located in the inner circumferential region (IN) in the radial direction of the magnetic disk 12, the central axis C1 of the slider forms a skew angle θ (negative) with respect to the recording direction (circumferential direction) C2 of the magnetic disk 12. When the skew angle θ is a negative angle, the distance DS2 between the write head WH and the read head RH2 in the recording direction C2 is smaller than the distance DS1 between the write head WH and the read head RH1 in the recording direction C2, for example, a half of the distance DS1 or less.

Therefore, when the magnetic head 16 is located in the inner circumferential region (IN) in the radial direction of the magnetic disk 12, the length of the non-recording region ds can be shortened by reading servo data using the read head RH2.

Note that according to this embodiment, the skew angle at each radial position of the magnetic head 16 is measured in advance and stored in the memory 47 as skew angle data. In one example, a data table in which each radial position is associated with the corresponding skew angle is stored in the memory 47.

During recording operation, the MPU 46 of the main controller 40 detects the radial position of the magnetic head at the start of recording operation, and the arithmetic circuit 46d reads the skew angle corresponding to the detected radial position from the data table in the memory 47. The determination circuit 46e determines whether the read skew angle is zero, positive, or negative.

When the skew angle θ is zero, that is, when the magnetic head 16 is located at the radial intermediate position (M), the determination circuit 46e arbitrarily selects either the read head RH1 or RH2 and notifies the read control unit 46b. In this manner, the main controller 40 uses the selected read head RH1 or RH2 for reading the servo data and executes the recording operation.

When the skew angle θ is positive, that is, when the magnetic head 16 is located in the outer circumferential region (OUT) in the radial direction of the magnetic head 16, the determination circuit 46e selects the read head with a shorter distance DS in the recording direction C2, that is, the read head RH1, and notifies the read control section 46b. With this operation, the main controller 40 uses the selected read head RH1 for reading the servo data and executes the recording operation.

When the skew angle θ is negative, that is, when the magnetic head 16 is located in the inner circumferential region (IN) in the radial direction of the magnetic head 16, the determination circuit 46e selects the read head with a shorter distance DS in the recording direction C2, that is, the read head RH2, and notifies the lead control section 46b. With this operation, the main controller 40 uses the selected read head RH2 for reading the servo data and executes the recording operation.

According to the HDD of the present embodiment configured as described above, the magnetic head 16 has a pair of read heads RH1 and RH2, and these read heads are placed offset in a direction intersecting the reference axis CX, which passes through the center point of the write head WH, that is, they are arranged on the respective sides of the reference axis CX. With such a configuration, each of the read heads RH1 and RH2 can be placed closer to the write head WH. That is, the distance RWS between each read head and the write head WH in the longitudinal direction of the slider can be shortened, for example, set to 3 μm or less. Thus, by shortening the distance RWS, the length of the non-recording area ds created during the recording operation can be reduced, thereby making it possible to achieve the reduction of the recording loss and improvement of the recording capacity.

Further, according to this embodiment, it is configured such that, during recording, depending on the radial position and skew angle of the magnetic head on the magnetic disk 12, one of the two read heads RH1 and RH2, which has a shorter distance (circumferential distance) DS between the write head and the read head in the recording direction, is selected for use in reading servo data. With this configuration, the length of the non-recording area ds created during recording operation can be further reduced, thereby making it possible to reduce the recording loss and improve the recording capacity.

As described above, according to the present embodiment, it is possible to provide a magnetic head which can reduce recording loss and improve recording capacity, and a magnetic disk device comprising the same.

Next, the magnetic recording head of an HDD according to another embodiment will be described. In the other embodiment to be provided below, the same parts as those used in the first embodiment are denoted by the same reference numerals and their detailed descriptions are omitted or simplified. The parts that differ from those of the first embodiment will be mainly described in detail.

### Second Embodiment

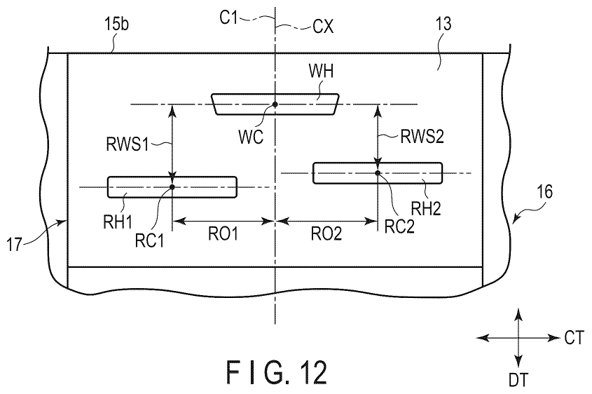

FIG. 12 is a plan view of the head portion, which shows an arrangement of a write head and a pair of read heads on the support surface (ABS) of the magnetic head of an HDD according to the second embodiment.

As shown in FIG. 12, according to the second embodiment, in the head portion 17 of the magnetic head 16, the distance RO1 between the read head RH1 and the reference axis CX, and the distance RO2 between the read head RH2 and the reference axis CX are set to different dimensions from each other. For example, RO1 is set to be less than RO2 (RO1<RO2). Further, the distance RWS1 between the write head WH and the reference axis CX in the down-track direction DT, and the distance RWS2 between the write head WH and the read head RH2, are set to different dimensions from each other. For example, RWS1 is set to be greater than RWS2 (RWS1>RWS2).

As shown in FIG. 4, between the main magnetic pole 60 of the write head 58 (WH) and the read heads 54a and 54b (RH1 and RH2), other components of the head portion 17, such as the second recording coil 72 and the leading shield 64, are provided. As shown in FIGS. 5 and 12, when the read heads RH1 and RH2 are placed offset in the cross-track direction relative to the reference axis CX, the above-listed other components can be avoided, thereby making it possible to place the read heads RH1 and RH2 closer to the write head WH side.

Here, according to the second embodiment, shown in FIG. 12, depending on the arrangement of the other components described above, one of the read heads can be placed closer to the write head WH than the other read head, that is, they can be placed with a shorter distance RWS.

In the second embodiment, the other configurations of the HDD and the magnetic head are similar to those of the HDD and magnetic head described in the first embodiment. Advantageous effects similar to those of the first embodiment can be obtained in the second embodiment as well. That is, according to the second embodiment, it is possible to provide a magnetic head which can reduce recording loss and improve recording capacity, and a magnetic disk device comprising the same.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

In the above-described embodiments, the main controller 40 is configured to read a skew angle corresponding to servo data (position information) from a data table, but the configuration is not limited to this. For example, such a configuration may as well do that the arithmetic circuit 46d is used to calculate the circumferential distance between the write head and the first read head in the recording direction (circumferential direction) and the circumferential direction between the write head and the second read head in the recording direction (circumferential direction), based on the position information, skew angle, and the positional relationship between the write head and the first read head and the second read head (RO1, RO2, RWS1, and RWS2), and the determination circuit 46e selects the read head with the shorter circumferential direction as the read head to be used for reading the position information.

What is claimed is

1. A magnetic head comprising:
a head slider including a rectangular support surface facing a recording medium and a reference axis extending in a longitudinal direction of the support surface;
a write head provided on the head slider, which applies a recording magnetic field to the recording medium and includes a head tip portion exposed to the support surface; and
a first read head and a second read head, each including a head tip portion provided on the head slider and exposed to the support surface, which read information recorded in a recording area of the recording medium and position information recorded in a servo data area of the recording medium,
wherein
the head tip portion of the write head includes a center portion placed on the reference axis,
the head tip portion of the first read head includes a center portion spaced apart from the reference axis by a first offset distance in a first side direction perpendicular to the reference axis, and in the longitudinal direction, spaced apart from the center portion of the head tip portion of the write head by a first interval,
the head tip portion of the second read head includes a center portion spaced apart from the reference axis by a second offset distance in a second side direction which is opposite to the first side direction, and in the longitudinal direction, spaced apart from the center portion of the head tip portion of the write head by a second interval, and
the first interval and the second interval are formed to be 2 μm or more and 3 μm or less.

2. The magnetic head of claim 1, wherein
the first offset distance and the second offset distance are each set to be 7.46 to 11.2 μm.

3. The magnetic head of claim 1, wherein
the first offset distance and the second offset distance are set to be substantially equal to each other.

4. The magnetic head of claim 1, wherein
the first interval and the second interval are set to be substantially equal to each other.

5. The magnetic head of claim 1, wherein
the first offset distance and the second offset distance are different from each other.

6. The magnetic head of claim 1, wherein
the first interval and the second interval are different from each other.

7. A magnetic disk device comprising:
a rotatable disk-shaped recording medium including a magnetic recording layer including a recording area in which data is recorded and a servo data area which stores position information;
a magnetic head of claim 1, which executes recording and reading of information with respect to the magnetic recording layer of the recording medium; and
a controller which controls operation of the magnetic head,
wherein
the controller comprises a determination circuit which, when executing a recording operation by the write head, selects one of the first read head and the second read head in accordance with a radial position of the magnetic recording layer where data is to be recorded, and sets the selected read head as a read head for reading the position information recorded in the servo data area.

8. The magnetic disk device of claim 7, wherein
the controller comprises an arithmetic circuit which detects a skew angle of the magnetic head, which corresponds to the radial position, and the determination circuit selects a read head to be used for reading the position information in accordance with the detected skew angle.

9. The magnetic disk device of claim 7, wherein
the controller comprises an arithmetic circuit which calculates an interval between the write head and the first read head in the circumferential direction, and an interval between the write head and the second read head in the circumferential direction, based on the radial position, the skew angle between the longitudinal direction of the head slider at the radial position and the circumferential direction of the recording medium, and a positional relationship between the write head, the first read head, and the second read head, and
the determination circuit selects a read head whose interval in the circumferential direction is shorter, as a read head to be used for reading the position information.
